(19) United States
(12) Patent Application Publication
(10) Pub. No.: US 2019/0073920 A1
(43) Pub. Date: Mar. 7, 2019

(54) METHOD FOR EDUCATING CHANGE AGENTS

(71) Applicant: Finish Agent, Inc., Reston, VA (US)

(72) Inventor: Gina Hiatt, Reston, VA (US)

(21) Appl. No.: 16/120,759

(22) Filed: Sep. 4, 2018

Related U.S. Application Data
(60) Provisional application No. 62/554,971, filed on Sep. 6, 2017.

(51) Int. Cl. G09B 19/00

(52) U.S. Cl. CPC G09B 19/00

(57) ABSTRACT

A novel method for educating change agents is disclosed. A method for life improvement is selected, and a method for educating change agents in the preferred implementation and administration of the selected method of life improvement is described. The method of educating change agents includes techniques for marketing, implementing, administering, and delegating the various components of the selected method of life improvement.

### PRIORITY CLAIM AND INCORPORATION BY REFERENCE

This application claims the priority of U.S. Provisional Patent Application No. 62/554,971, also titled METHOD FOR EDUCATING CHANGE AGENTS, with an application filing date of Sep. 6, 2017, filed in the United States Patent and Trademark Office. The invention as disclosed in the 62/554,971 application and as claimed herein was invented by the same inventive entity, and the entirety of the 62/554,971 application is incorporated herein by reference to provide continuity of disclosure.

This invention relates to a novel method for educating change agents regarding a selected life improvement method. By teaching change agents the novel method for continuously encouraging their clients to participate in the selected life improvement method, overall success with life improvement goals is achieved. Implementation of the method of the invention also establishes a business model which improves the administration of a business which delivers life improvement services to clients.

### BACKGROUND OF THE INVENTION

People who wish to improve their lives (generally “clients”) have long used life improvement methods invented and/or administered by others (generally, “change agents.”) However, while these methods often involve the setting and (attempted) achievement of goals, historically getting clients to set those goals and follow through on them has been difficult. A method for educating change agents which enables change agents to make it more likely that clients will set goals and follow through on them will be a useful invention.

A known method of enhancing the success of life improvement methods is to incorporate group support into the method. A method for educating change agents which enables change agents to incorporate group support into life improvement methods in a structured and novel way will be a useful invention.

The more rigorous the structure of a life improvement method, the more likely it is to achieve its goal, but the more difficult it becomes for clients to adhere to the method. A method for educating change agents which enables them to incorporate structure, including but not limited to daily reinforcement, will be a useful invention.

The present invention addresses these concerns.

### SUMMARY OF THE INVENTION

Among the many objectives of the present invention is the provision of a method for educating change agents.

Another objective of the present invention is the provision of a method for educating change agents as to how to administer a novel life improvement method.

Yet another objective of the present invention is the provision of a method for educating change agents that provides an inherent group support mechanism while providing individual support for administering a novel life improvement method.

Still another objective of the present invention is the provision of a method for educating change agents that provides a self-reinforcing structure for administering a novel life improvement method.

A further objective of the present invention is the provision of a method for educating change agents that provides a method for administering a novel life improvement method in a manner which is both economically sound and effective in creating change.

Other objectives and advantages of the invention will become apparent from the description of the preferred embodiment herein.

### BRIEF DESCRIPTION OF THE DRAWINGS

FIG. 1 is a flow chart showing the overall method of the invention.

FIG. 2 is a flow chart showing the sub-steps of the method of the invention comprising STEP 100.

FIG. 3 is a flow chart showing the sub-steps of the method of the invention comprising STEP 200.

FIG. 4 is a flow chart showing the sub-steps of the method of the invention comprising STEP 300.

FIG. 5 is a flow chart showing the sub-steps of the method of the invention comprising STEP 500.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, may be used with respect to the drawings. These and similar directional terms are not to be construed to limit the scope of the invention in any manner. The words attach, connect, couple, and similar terms with their inflectional morphemes do not necessarily denote direct or intermediate connections, but may also include connections through mediate elements or devices.

The present invention related to a method for educating change agents in the administration and use of a life improvement method. Though the method could be applied to any suitable life improvement method, in the preferred embodiment, the life improvement method is itself a novel method for life improvement.

Note that while the change agent to which the description of the preferred embodiment refers may be a licensed health care professional, it is not required for purposes of the invention. If otherwise reasonable and allowed by applicable law and regulation, the method of the invention may be used to educate non-licensed persons such as advisors, consultants, or life coaches as to the implementation and administration of the method of life improvement. Similarly, if allowed by applicable law and regulation, and otherwise within their scope of practice, the method may be used by licensed health care professionals.

Likewise, the method of life improvement being used as part of the method of educating change agents may or may not be administered by a licensed health care professional. Legal and regulatory requirements in any given jurisdiction may require, non-exclusively, that a) the method of life improvement be administered under the supervision of a licensed health care professional or b) the method of life improvement's administration be accompanied by appropriate disclaimers. To the extent that any of the proceeding apply to a particular method of life improvement, it shall be referred to herein as a “regulated method of life improvement.” For purposes of this application, it should be understood that:

1) The invention itself is a method for educating change agents in the administration of a method of life improvement, and any particular method of life improvement may or may not be a regulated method of life improvement. “Life improvement” may include, but is not limited to, the treatment, cure, or prevention of disease.

2) To the extent that a particular embodiment of the invention involves a regulated method of life improvement, nothing herein should be read as making any particular guarantee of outcome when applied in any individual case. At the time of filing, no statement herein has been evaluated by the Food and Drug Administration or any analogous regulatory agency. The method of the invention should not be used to educate change agents on the diagnosis, treatment, cure, or prevention of any disease unless it includes appropriate regulatory controls and information. Such regulatory controls will vary by jurisdiction and do not form part of the fundamental method of the invention, and will not be further described herein.

The method of the invention comprises a series of steps, each of which may comprise a single step or a plurality of substeps. Each step will be described herein: additional information about the nature and purpose of each step may be found in the supplemental specification documents filed herewith. The order of the steps is not fixed: while it is required that optional STEP 100 always be performed first if at all, and it is strongly preferred that STEP 200 and STEP 300 should be performed (in any order) before the rest of the steps, persons of ordinary skill in the art will see that otherwise while the order disclosed herein is preferred, it is not required.

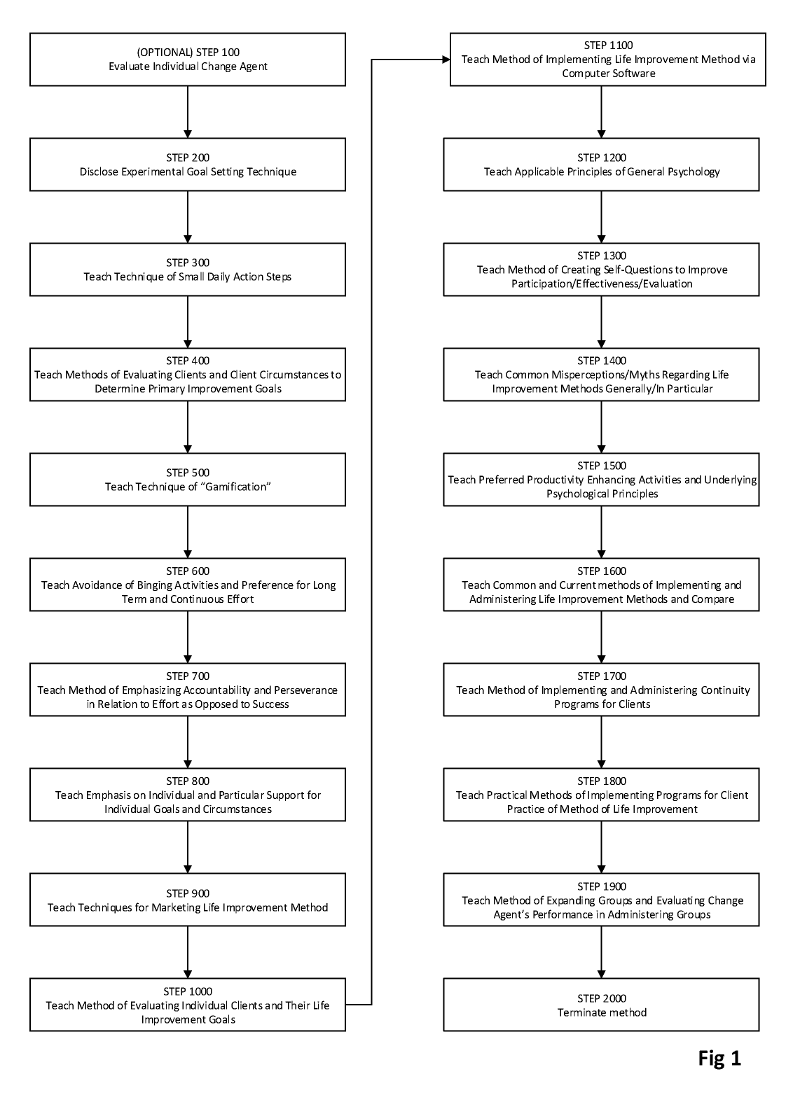

The preferred embodiment of the invention will be described in relation to its major steps as set forth in FIG. 1. Where a major step has substeps, those substeps will be shown in an additional figure which will be referenced in the description of that major step. Major steps are referred to as “STEPS,” and substeps as “SUBSTEPS.”

Optional STEP 100 evaluates an individual change agent for compatibility with the method of life improvement the method is meant to teach. This includes evaluation of temperament, preferred client interaction style, and other relevant factors. If the change agent is already certain that they wish to learn the method of life improvement the method is meant to teach, and/or they are required to learn it, this step may be omitted.

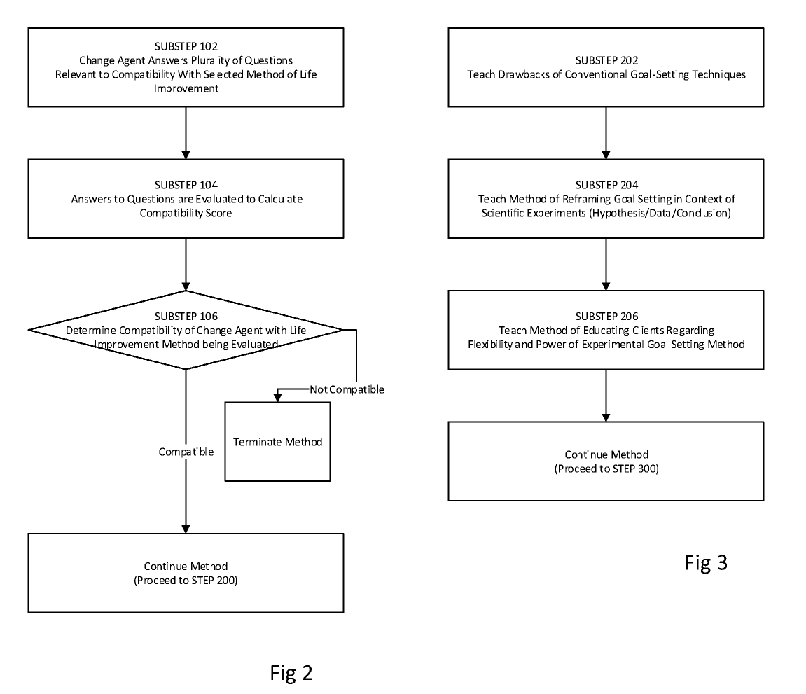

As shown in FIG. 2, STEP 100 includes:
1) SUBSTEP 102, in which the change agent answers a plurality of questions, each associated with a score, designed to evaluate the change agent for compatibility with the method of life improvement;
2) SUBSTEP 104, in which the answers given in the previous substep are evaluated and a net score is calculated, and;
3) SUBSTEP 106, in which the score is compared to a score ranking designed to indicate whether the change agent is compatible with the method of life improvement.

If STEP 100 indicates that the change agent is compatible with the method of life improvement to be taught by the method of the invention, the method continues. Otherwise, the method terminates.

It is optional, but not required, to repeat STEP 100 with regard to one or more alternate methods of life improvement to determine whether some alternate method of life improvement is more compatible with the change agent being evaluated. If a method of life improvement which is compatible with the change agent being evaluated is found, the method continues. It is optional, but not required, to evaluate a plurality of life improvement methods for compatibility with the change agent being evaluated, and select the life improvement method with the highest compatibility or from one or more life improvement methods with a minimum level of compatibility based on a minimum score.

In STEP 200, the technique of Experimental Goal Setting (see definition in supplemental specification) is disclosed to the change agent for educational purposes.

As shown in FIG. 3, STEP 200 includes:
a) SUBSTEP 202, in which the change agent is taught the drawbacks of conventional goal-setting techniques;
b) SUBSTEP 204, in which the change agent is taught to reframe goal setting in the context of scientific experiments, in which a hypothesis is framed, experiments are done, data is collected, and the hypothesis is changed to reflect the results; and,
c) SUBSTEP 206, in which the change agent is taught to educate clients as to the flexibility and power of the Experimental Goal Setting technique.

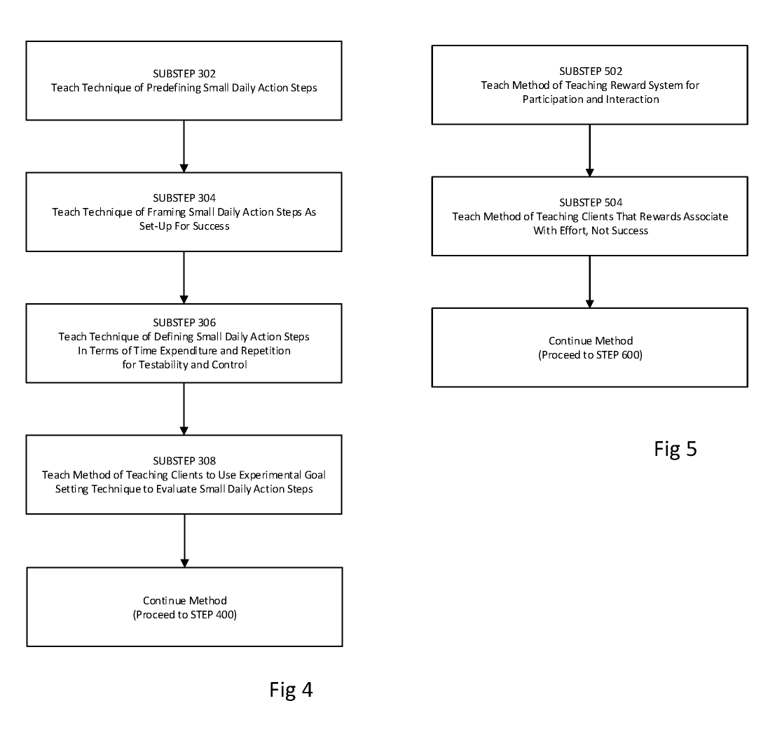

For purposes of this disclosure, the Experimental Goal Setting technique is an adaptation of what is commonly referred to as the scientific or experimental method, and comprises the following:
1) Framing a hypothesis as to what goals would be most beneficial to reach with respect to the life improvement method.
2) Performing one or more experiments with Small Daily Action Steps (see STEP 300 and FIG. 4) to determine what actions are likely to further the goals hypothesized in Step 1.
3) Evaluating the result of the experiment(s) in Step 2 as to their effect on the furtherance of the goals selected in Step 1.
4) If the evaluation of Step 3 is not positive, selecting new Small Daily Action Steps and repeating the experiment(s) of Step 2.
5) If the evaluation of Step 3 is positive, evaluating the effect of achieving the goals with regard to the life improvement method.
6) If the evaluation of Step 5 is not positive, framing a new hypothesis and proceeding from Step 1.
7) If the evaluation of Step 5 is positive, continuing to perform the Small Daily Action Goals of Step 2 until the goal is achieved.

It is required that the change agent be educated to make clear to clients that the experimental method's results are relative, not absolute, and that if they do not serve to advance the goals, it is not a failure on the part of the client, but merely an indicator that a new set of goals and/or a new hypothesis must be framed.

The method then continues.

In STEP 300, the technique of Small Daily Action Steps is disclosed to the change agent for educational purposes.

As shown in FIG. 4, STEP 300 includes:
a) SUBSTEP 302, in which the change agent is taught the technique of defining Small Daily Action Steps ahead of time;
b) SUBSTEP 304, in which the change agent is taught to frame the technique of Small Daily Action Steps for clients as a set-up for success;
c) SUBSTEP 306, in which the change agent is taught to teach clients to define Small Daily Action Steps in terms of net time expenditure and/or repetition of steps so that success is both testable and within the control of the client; and,
d) SUBSTEP 308, in which the change agent is taught to teach clients to use the technique of Experimental Goal Setting (see STEP 200) to determine whether the Small Daily Action Steps defined are reasonable and helpful. If not, they should be redefined. If so, they should be continued.

For purposes of this disclosure, the technique of setting Small Daily Action Steps is defined as the following:
1) Determining one or more important actions that would significantly improve the life of the client implementing the life improvement method.
2) Evaluating the actions to determine one or more actions which the client typically procrastinates regarding and which cannot be delegated.
3) Selecting one or more of the actions determined in Step 2 which could be addressed by a daily action step.
4) Selecting one of the actions determined in Step 3 which is most important to the client's goals regarding the life improvement method.
5) Determining an amount of time to perform this action daily, making it a Small Daily Action Step. It is strongly preferred, but not required, that the amount of time be not more than thirty minutes and not less than fifteen minutes.

The method then continues.

In STEP 400, the change agent is taught methods of evaluating clients and their current situation and application of the methods of STEP 200 and

STEP 300 to determine where clients need help and how to support them accordingly. The method then continues.

In STEP 500, the change agent is taught the technique of “gamification,” which encourages participation in the method of life improvement by providing fixed rewards for participation.

As shown in FIG. 5, STEP 500 includes:
1) SUBSTEP 502, in which the change agent is taught to teach the client to set up a system of rewards both for doing things such as setting and performing Small Daily Action steps and for interacting with other participants in the method of life improvement for purposes of mutual encouragement; and,
2) SUBSTEP 504, in which the change agent is taught to teach clients that rewards should be associated with effort, not success, because effort is always within the client's control.

The method then continues.

In STEP 600, the change agent is taught to teach clients to avoid “binge working,” or attempting to achieve goals through long, complex, and concentrated “binging” activities. The change agent is taught to teach clients to persevere in long-term efforts such as continued usage of Small Daily Action Steps as a more effective and persistent way of improving one's life. The method then continues.

In STEP 700, the change agent is taught to teach clients to emphasize accountability and perseverance as the most important ways to perform the method of life improvement. As in SUBSTEP 504, it is emphasized that effort, not success, is the preferred method of gauging performance of the method of life improvement, and long-term results require long-term performance. The method then continues.

In STEP 800, the change agent is taught to emphasize particular support for the particular needs and goals of individual clients and to avoid providing large amounts of general information related to the method. In particular, the change agent is taught to avoid “infodumps,” or large amounts of general information regarding all possible applications of the method of life improvement in favor of finding out what the client's most pressing goals are and supporting movement toward those goals. The method then continues.

In STEP 900, the change agent is taught the preferred techniques for marketing the method of life improvement. It is preferred that the preferred techniques be used not only to maximize the success of the change agent in attracting and retaining clients, but to correctly frame the method of life improvement as it is introduced to the client to increase the chances of ultimate success. The method then continues.

In STEP 1000, the change agent is taught to evaluate individual clients and their life improvement goals to determine whether the method of life improvement being taught is suitable for an individual client. It is preferred to teach this step after teaching the fundamentals of the method of life improvement as it gives the change agent context for the evaluation process. However, when the method of life improvement is administered by the change agent, it is preferred that this step be performed before any other steps of administering the method of life improvement. If the evaluation indicates that the method of life improvement is not suitable for the client, the administration of the method of life improvement should be terminated. The method then continues.

In STEP 1100, the change agent is taught to implement the method of life improvement through computer software, including the use of global computer network enabled devices to
a) allow clients to track their progress;
b) allow the change agent to track the progress of clients;
c) allow groups of clients to track each other's progress and provide mutual support; and,
d) allow either the client or the change agent to create and set new Small Daily Action Goals using the technique of Experimental Goal Setting.

It is strongly preferred, but not required to include all of the functionality set forth above in the computer software implementation of the method of life improvement. The method then continues.

In STEP 1200, the change agent is taught applicable principles of general psychology which are useful in implementing and administering the method of life improvement for clients. In the preferred embodiment, this includes such known techniques as cognitive-behavioral therapy, classical and operant conditioning, and the basics of neuropsychology regarding learning and habit formation. It is required that this step be performed, but the actual content provided can vary according to the specific method of life improvement the change agent is being taught to implement and administer. The method then continues.

In STEP 1300, the change agent is taught to craft suitable questions for clients which they can ask themselves on a daily basis to encourage participation in the method of life improvement, to reinforce the effect of the method of life improvement by suggestion and proper framing, and to evaluate the current progress of the method of life improvement. Teaching change agents to incorporate daily accountability of clients and maximize follow-through of clients regarding the method of life improvement by means of asking and answering questions is a required feature of the method of the invention. The method then continues.

In STEP 1400, the change agent is taught about common misperceptions or “myths” regarding methods of life improvement in general and the method of life improvement being implemented and administered in particular. The change agent is also taught how to reveal these myths to clients to increase the chances that clients will implement and maintain the method of life improvement. The method then continues.

In STEP 1500, the change agent is taught about preferred productivity enhancing activities and the psychological principles behind them so that they can in turn evaluate individual clients and suggest appropriate productivity enhancing activities. This includes, but is not limited to, activities that will increase the productivity of the method of life improvement. The method then continues.

In STEP 1600, the change agent is taught about the most common conventional and current methods of implementing and administering life improvement methods, along with the distinctions from those methods that the method of life improvement currently being taught involves. The method then continues.

In STEP 1700, the change agent is taught how to implement and administer continuity programs for clients which maximize the long-term success of the method of life improvement by ensuring that they will continue to practice the method of life improvement after any immediate goals may be achieved. The method then continues.

In STEP 1800, the change agent is taught practical methods of implementing programs for clients to practice the method of life improvement. This includes an introduction to any particular computer software designed to implement the method of life improvement, preferred ways of introducing the method of life improvement, orienting clients to it, and assisting clients in defining and setting goals for life improvement. Teaching change agents to impose defined structure on clients participating in the life improvement method by the use of predefined and specific methods of implementing the method of life improvement is a required feature of the method of the invention. The method then continues.

In STEP 1900, the change agent is taught how to expand groups of clients mutually participating in the method of life improvement through the definition and maintenance of various group levels, each level corresponding to a particular numeric range of participating clients. The change agent is also taught how to evaluate and improve their implementation and administration of the method of life improvement at each group level. The method then continues. The inclusion of instruction regarding groups of clients who interact with each other to encourage participation in the method of life improvement is a required feature of this method.

In STEP 2000, the change agent is taught how to supervise sub-administrators of the method of life improvement. This includes hiring, training, and supervising subordinate change agents to implement and administer the method of life improvement. It can optionally include teaching subordinate change agents how to train other change agents in the method of the invention.

After STEP 2000, the method terminates, although periodic continuing and reinforcing education on the method of life improvement can be applied by repeating one or more of the steps at any time.

As will be apparent to persons of ordinary skill in the art, the method of the invention could be incorporated into a software program which could be executed on a computer or other suitable electronic device. (Not shown.) While the method of the invention may be performed manually, on a computer, or as a mixture of manual and electronic performance steps, performing the method itself on a computer (including electronic documentation materials) is neither preferred nor required. A computer or other electronic system incorporating the method of the invention is an alternate embodiment off the invention.

Such a system would usually incorporate a digital computer comprising a Central Processing Unit (CPU,) a Random Access Memory (RAM) and/or a persistent storage device such as a hard drive, an input device such as a keyboard, and a visual display such as an LCD monitor, the RAM and/or the persistent storage device, the input device, and the visual display operably connected to the CPU. Instructions corresponding to the method of the invention would be stored in the RAM and/or persistent storage device, executed by the CPU, and displayed on the visual display, with input from the change agent being educated accepted via the input device.

While various embodiments and aspects of the present invention have been described above, it should be understood that they have been presented by way of example only, and not limitation. Thus, the breadth and scope of the present invention should not be limited by any of the above exemplary embodiments.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed and sought to be protected by Letters Patent is:

1) A method for educating change agents comprising the steps of:
a) disclosing an Experimental Goal Setting Technique to a change agent, including disclosing a plurality of drawbacks of conventional goal-setting techniques, disclosing a technique of reframing goal setting in the context of scientific experiments, and disclosing a technique of educating a client as to a plurality of advantages of the Experimental Goal Setting technique;
b) disclosing a technique of Small Daily Action Steps to the change agent, including disclosing a technique of defining a plurality of Small Daily Action Steps ahead of time, disclosing a technique of framing the plurality of Small Daily Action Steps to the client so as to encourage success in a technique of undertaking Small Daily Action Steps, disclosing a technique of teaching the client to define Small Daily Action Steps in terms of a net time expenditure and/or repetition of a plurality of steps so that success of the technique of undertaking Small Daily Action Steps is both testable and within the control of the client, and disclosing a technique of teaching clients to use the technique of Experimental Goal Setting to determine whether the technique of undertaking Small Daily Action Steps is being successfully applied;
c) disclosing a technique for evaluating the client and a current client situation to determine where the client needs assistance and how to support the client in implementing the technique of Experimental Goal Setting and the technique of undertaking Small Daily Action Steps;
d) disclosing a technique of gamification, the technique of gamification including the steps of teaching the change agent to encourage participation in a method of life improvement by providing a plurality of fixed rewards for participation to the client, teaching the change agent to teach the client to set up the system of fixed rewards both for performing a plurality of actions meant to implement the method for life improvement and for interacting with a plurality of other participants in the method of life improvement, and teaching the change agent to teach clients that the system of fixed rewards should be associated with a plurality of efforts to implement the life improvement method;
e) teaching the change agent to teach the client to avoid a technique of binge working and to teach the client to persevere in a plurality of long-term efforts to implement the life improvement method;
f) teaching the change agent to teach the client to emphasize accountability and perseverance as a preferred way to perform the method of life improvement;
g) teaching the change agent to emphasize support for a plurality of particular needs and goals of the client and to avoid providing a plurality of items of general information related to the method;
h) teaching the change agent a plurality of preferred techniques for marketing the method of life improvement;
i) teaching the change agent to evaluate a plurality of individual clients and their life improvement goals to determine whether the method of life improvement being taught is suitable for any one of the plurality of individual clients;
j) teaching the change agent to implement the method of life improvement through a plurality of computer programs;
k) teaching the change agent a plurality of applicable principles of general psychology, the applicable principles of general psychology being useful in implementing and administering the method of life improvement for the client;
l) teaching the change agent to craft a plurality of suitable questions for the client, the plurality of suitable questions being useful to the client for encouraging participation in the method of life improvement, reinforcing the effect of the method of life improvement, and evaluating a current progress of the method of life improvement;
m) teaching the change agent about a plurality of common misperceptions regarding both a plurality of distinct methods of life improvement and the method of life improvement and teaching the change agent how to disclose the plurality of common misperceptions to the client to increase the chances that that the client will implement and maintain the method of life improvement;
n) teaching the change agent about a plurality of preferred productivity enhancing activities and a plurality of associated psychological principles related to the plurality of preferred productivity enhancing activities so that the change agent can evaluate the client and suggest that the client implement some or all of the plurality of preferred productivity enhancing activities;
o) teaching the change agent about a plurality of common conventional methods of implementing and administering life improvement methods, along with a plurality of distinctions between the plurality of common conventional methods of implementing and administering life improvement methods and the method of life improvement;
p) teaching the change agent how to implement and administer a plurality of continuity programs for the plurality of individual clients;
q) teaching the change agent a plurality of practical methods of implementing a plurality of programs for the plurality of individual clients to practice the method of life improvement;
r) teaching the change agent how to expand a plurality of groups of clients mutually participating in the method of life improvement through the definition and maintenance of a plurality of group levels, each of the group levels corresponding to a particular numeric range of participating clients; and,
s) teaching the change agent how to supervise a plurality of sub-administrators of the method of life improvement.

2. A method for educating change agents as in claim 1, further comprising:
a) A change agent compatibility evaluation process step, the change agent compatibility evaluation process step being performed before any other step and comprising the steps of:
i. asking the change agent to answer a plurality of change agent compatibility questions, each change agent compatibility question associated with an individual compatibility question score, the change agent compatibility questions designed to evaluate the change agent for compatibility with the method of life improvement;
ii. evaluating the individual compatibility question scores and calculating a net compatibility score;
iii. Comparing the net compatibility score to a score ranking, the score ranking designed to indicate whether the change agent is compatible with the method of life improvement;
iv. terminating the method of educating change agents if the score ranking indicates that the change agent is not compatible with the method of life improvement; and,
v. otherwise, continuing the method of educating change agents.

3) A device for educating change agents comprising:
a) a digital computer comprising a CPU, a RAM and/or a persistent storage device, an input device, and a visual display, the RAM and/or the persistent storage device, the input device, and the visual display operably connected to the CPU;
b) a set of instructions stored on the RAM and/or the persistent storage device which are executed by the CPU and cause the digital computer to perform the following operations;
i. displaying an Experimental Goal Setting Technique to a change agent, including displaying a plurality of drawbacks of conventional goal-setting techniques, displaying a technique of reframing goal setting in the context of scientific experiments, and displaying a technique of educating a client as to a plurality of advantages of the Experimental Goal Setting technique;
ii. displaying a technique of Small Daily Action Steps to the change agent, including displaying a technique of defining a plurality of Small Daily Action Steps ahead of time, displaying a technique of framing the plurality of Small Daily Action Steps to the client so as to encourage success in a technique of undertaking Small Daily Action Steps, displaying a technique of teaching the client to define Small Daily Action Steps in terms of a net time expenditure and/or repetition of a plurality of steps so that success of the technique of undertaking Small Daily Action Steps is both testable and within the control of the client, and displaying a technique of teaching clients to use the technique of Experimental Goal Setting to determine whether the technique of undertaking Small Daily Action Steps is being successfully applied;
iii. displaying a technique for evaluating the client and a current client situation to determine where the client needs assistance and how to support the client in implementing the technique of Experimental Goal Setting and the technique of undertaking Small Daily Action Steps;
iv. displaying a technique of gamification, the technique of gamification including the steps of teaching the change agent to encourage participation in a method of life improvement by providing a plurality of fixed rewards for participation to the client, teaching the change agent to teach the client to set up the system of fixed rewards both for performing a plurality of actions meant to implement the method for life improvement and for interacting with a plurality of other participants in the method of life improvement, and teaching the change agent to teach clients that the system of fixed rewards should be associated with a plurality of efforts to implement the life improvement method;
v. displaying a perseverance technique to the change agent to teach the client to avoid a technique of binge working and to teach the client to persevere in a plurality of long-term efforts to implement the life improvement method;
vi. displaying an accountability technique to the change agent to teach the client to emphasize accountability and perseverance as a preferred way to perform the method of life improvement;
vii. displaying a support technique to the change agent to emphasize support for a plurality of particular needs and goals of the client and to avoid providing a plurality of items of general information related to the method;
viii. displaying a plurality of marketing techniques to the change agent for marketing the method of life improvement;
ix. displaying an evaluation technique to the change agent to teach the change agent to evaluate a plurality of individual clients and their life improvement goals to determine whether the method of life improvement being taught is suitable for any one of the plurality of individual clients;
x. displaying a plurality of computer program techniques to the change agent to teach the change agent to implement the method of life improvement through a plurality of computer programs;
xi. displaying a plurality of applicable principles of general psychology to the change agent, the applicable principles of general psychology being useful in implementing and administering the method of life improvement for the client;
xii. displaying a technique of creating suitable questions to the change agent to teach the change agent to craft a plurality of suitable questions for the client, the plurality of suitable questions being useful to the client for encouraging participation in the method of life improvement, reinforcing the effect of the method of life improvement, and evaluating a current progress of the method of life improvement;
xiii. displaying a plurality of common misperceptions regarding methods of life improvement to the change agent regarding both a plurality of distinct methods of life improvement and the method of life improvement to teach the change agent how to disclose the plurality of common misperceptions to the client to increase the chances that that the client will implement and maintain the method of life improvement;
xiv. displaying a plurality of preferred productivity enhancing activities to the change agent and a plurality of associated psychological principles related to the plurality of preferred productivity enhancing activities so that the change agent can evaluate the client and suggest that the client implement some or all of the plurality of preferred productivity enhancing activities;
xv. displaying a plurality of common conventional methods of implementing and administering life improvement methods to the change agent, along with a plurality of distinctions between the plurality of common conventional methods of implementing and administering life improvement methods and the method of life improvement;
xvi. displaying a plurality of continuity programs to the change agent to teach the change agent how to implement and administer the plurality of continuity programs for the plurality of individual clients;
xvii. displaying a plurality of implementation programs to the change agent to teach the change agent a plurality of practical methods of implementing a plurality of programs for the plurality of individual clients to practice the method of life improvement;
xviii. displaying a system of group levels to the change agent to teach the change agent how to expand a plurality of groups of clients mutually participating in the method of life improvement through the definition and maintenance of a plurality of group levels, each of the group levels corresponding to a particular numeric range of participating clients; and,
xix. displaying a supervision technique to the change agent to teach the change agent how to supervise a plurality of sub-administrators of the method of life improvement.
